(19) United States
(12) Patent Application Publication
(10) Pub. No.: US 2025/0226768 A1
(43) Pub. Date: Jul. 10, 2025

(54) ELECTRIC CIRCUIT

(71) Applicant: DAIKIN INDUSTRIES, LTD., Osaka (JP)

(72) Inventors: Kazuma TANIMUKAI, Osaka (JP); Hirotaka DOI, Osaka (JP); Masaki KONO, Osaka (JP); Tomoisa TANIGUCHI, Osaka (JP)

(21) Appl. No.: 19/091,547

(22) Filed: Mar. 26, 2025

Related U.S. Application Data
(63) Continuation of application No. PCT/JP2023/031591, filed on Aug. 30, 2023.

(30) Foreign Application Priority Data
Sep. 30, 2022 (JP) 2022-157757

(51) Int. Cl. H02M 7/537; H01C 7/12; H02M 7/04

(52) U.S. Cl. CPC H02M 7/537; H02M 7/04; H01C 7/12

(57) ABSTRACT

An electric circuit includes a power source unit, and a main circuit unit configured to receive electric power from a power source via the power source unit. The power source unit includes a bypass path and an impedance increasing circuit. The bypass path allows part of a current including a lightning surge current superimposed on a current from the power source to flow. The impedance increasing circuit increases an equivalent impedance between the power source and the main circuit unit based on the current flowing through the bypass path.

### CROSS-REFERENCE TO RELATED APPLICATIONS

This is a continuation of International Application No. PCT/JP2023/031591 filed on Aug. 30, 2023, which claims priority under 35 U.S.C. § 119 (a) to Patent Application No. 2022-157757, filed in Japan on Sep. 30, 2022, all of which are hereby expressly incorporated by reference into the present application.

### BACKGROUND

### Technical Field

The present disclosure relates to an electric circuit including a power source unit and a main circuit unit configured to receive electric power from a power source via the power source unit.

### Background Information

Japanese Unexamined Patent Publication No. 2020-124104 discloses an electric circuit including a power source unit and a main circuit unit configured to receive electric power from an AC power source via the power source unit. In this electric circuit, the power source unit includes a reactor and a converter circuit, and the main circuit unit includes a capacitor and an inverter circuit.

### SUMMARY

A first aspect is an electric circuit including a power source unit and a main circuit unit configured to receive electric power from a power source via the power source unit. The power source unit includes: a bypass path configured to allow part of a current including a lightning surge current superimposed on a current from the power source to flow; and an impedance increasing circuit configured to increase an equivalent impedance between the power source and the main circuit unit based on the current flowing through the bypass path.

### BRIEF DESCRIPTION OF THE DRAWINGS

FIG. 1 is a circuit diagram showing a configuration of a power converter as an electric circuit according to a first embodiment of the present disclosure.

FIG. 2 is a view corresponding to FIG. 1, illustrating a comparative example.

FIG. 3 is a chart showing a voltage across a bypass path, an input voltage of a main circuit unit, a voltage in a main winding, and an input current of the main circuit unit measured in the comparative example.

FIG. 4 is a timing chart showing a voltage across a bypass path, an input voltage of a main circuit unit, a voltage in a main winding, an input current of the main circuit unit, and a voltage in an auxiliary winding measured in the first embodiment with solid lines, and the voltage across the bypass path, the input voltage of the main circuit unit, the voltage in the main winding, and the input current of the main circuit unit measured in the comparative example with broken lines.

FIG. 5 is a view corresponding to FIG. 1, illustrating a variation of the first embodiment.

FIG. 6 is a view corresponding to FIG. 1, illustrating a second embodiment.

FIG. 7 is a view corresponding to FIG. 1, illustrating a third embodiment.

FIG. 8 is a view corresponding to FIG. 1, illustrating a variation of the third embodiment.

FIG. 9 is a view corresponding to FIG. 1, illustrating a fourth embodiment.

### DETAILED DESCRIPTION OF EMBODIMENT(S)

Embodiments of the present disclosure will be described in detail with reference to the drawings. The following embodiments are merely exemplary ones in nature, and are not intended to limit the scope, application, or use of the present invention.

### FIRST EMBODIMENT

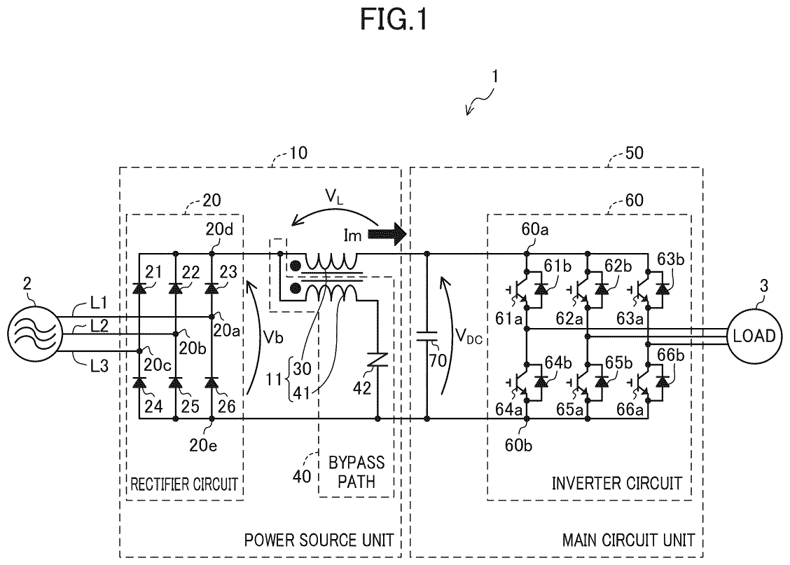

FIG. 1 shows a power converter (1) which is an electric circuit according to a first embodiment of the present disclosure. The power converter (1) converts an alternating current inputted from a power source (2) into an alternating current having desired frequency and voltage and supplies the alternating current to a load (3). The power source (2) is a three-phase AC power source. The load (3) is a motor.

The power converter (1) includes a power source unit (10), a main circuit unit (50) configured to receive electric power from the power source (2) via the power source unit (10), and a control device (not shown).

The power source unit (10) includes a rectifier circuit (20), a main winding (30), and a bypass path (40).

The rectifier circuit (20) rectifies a three-phase alternating current outputted from the power source (2) to first to third power lines (L1 to L3) into a direct current. The rectifier circuit (20) includes first to third input terminals (20a to 20c) connected to the first to third power lines (L1 to L3), and first and second output terminals (20d, 20e) for outputting a direct current. Specifically, the rectifier circuit (20) is a full-wave rectifier circuit. The rectifier circuit (20) includes six diodes (21 to 26) that serve as bridge-connected rectifier elements. The diodes (21 to 26) have cathodes directed toward the first output terminal (20d) and anodes directed toward the second output terminal (20e).

The main winding (30) is provided on a path for supplying the electric power from the power source (2) to the main circuit unit (50). Specifically, one end of the main winding (30) is connected to the first output terminal (20d) of the rectifier circuit (20), and the other end of the main winding (30) is connected to the main circuit unit (50) which will be described later in detail. That is, the main winding (30) is connected in series to the rectifier circuit (20) and the main circuit unit (50).

Both ends of the bypass path (40) are connected to the first and second output terminals (20d, 20e) of the rectifier circuit (20). In the bypass path (40), an auxiliary winding (41) magnetically coupled to the main winding (30) and a varistor (42) that serves as a surge absorber connected in series to the auxiliary winding (41) are provided in order from the first output terminal (20d). The main winding (30) and the auxiliary winding (41) have polarities in the same direction.

The main winding (30) and the auxiliary winding (41) constitute an impedance increasing circuit (11) configured to increase an equivalent impedance between the power source (2) and the main circuit unit (50) based on the current flowing through the bypass path (40). The equivalent impedance means |Vb|/|Im|, where Vb is a voltage across the bypass path (40) and Im is a current flowing from the power source unit (10) to the main circuit unit (50).

The main circuit unit (50) includes an inverter circuit (60) and a capacitor (70).

The inverter circuit (60) converts the direct current outputted from the rectifier circuit (20) into a three-phase alternating current by a switching operation and supplies the three-phase alternating current to the load (3). The inverter circuit (60) is controlled by a control device (not shown) by a pulse width modulation (PWM) method. Specifically, the inverter circuit (60) includes six switching elements (61a to 66a) and six freewheeling diodes (61b to 66b). The six switching elements (61a to 66a) are bridge-connected. More specifically, the inverter circuit (60) includes three switching legs connected between first and second input nodes (60a, 60b). Each switching leg is formed by connecting two of the switching elements (61a to 66a) in series. The first input node (60a) is connected to the other end of the main winding (30), and the second input node (60b) is connected to the second output terminal (20e) of the rectifier circuit (20).

In each of the three switching legs, a midpoint between the switching element (61a to 63a) of the upper arm and the switching element (64a to 66a) of the lower arm is connected to a coil of each phase (a u-phase coil, a v-phase coil, or a w-phase coil) of the load (3). Each of the switching elements (61a to 66a) is connected to a corresponding one of the freewheeling diodes (61b to 66b) in inverse parallel. Each of the switching elements (61a to 66a) is constituted of an insulated gate bipolar transistor (IGBT). However, the switching elements (61a to 66a) may be constituted of power metal oxide semiconductor field effect transistors (MOSFETs) including wide bandgap semiconductors such as silicon carbide (SiC) and gallium nitride (GaN).

The capacitor (70) is connected between the first and second input nodes (60a, 60b) of the inverter circuit (60). The capacitor (70) is a film capacitor or a ceramic capacitor. The film capacitor and the ceramic capacitor generally have a smaller capacitance than electrolytic capacitors, and thus the capacitor (70) does not sufficiently smooth the output voltage of the rectifier circuit (20). In other words, the capacitor (70) allows the output voltage of the rectifier circuit (20) to pulsate. Thus, the voltage between the first and second input nodes (60a, 60b) of the inverter circuit (60) has a pulsating component. The rectifier circuit (20) performs full-wave rectification, and thus the frequency of the pulsating component is 2N times the frequency of the AC voltage outputted from the power source (2) (N is the number of phases of the power source (2)).

Here, the inductance of the main winding (30) and the capacitance of the capacitor (70) are set to meet the following expression 1, where L (H) is the inductance of the main winding (30), fc (Hz) is the carrier frequency of the PWM control of the inverter circuit (60), C (F) is the capacitance of the capacitor (70), and the value of a constant K is ¼.

$$\begin{matrix}Math 1 & \\ \frac{1}{2 π \sqrt{LC}} ≦ K \cdot fc & ( Expression 1 )\end{matrix}$$

This allows the main winding (30) and the capacitor (70) to absorb switching noise generated in the inverter circuit (60). The switching elements (61a to 66a) may be power MOSFETs which are made of silicon carbide or gallium nitride and can perform high speed switching. This can increase the carrier frequency fc, and can reduce the inductance of the main winding (30) and the capacitance of the capacitor (70).

The capacitance of the capacitor (70) is set to meet the following expression 2, where Vac (V) is the voltage of the power source (2) and Pmax (W) is the maximum power consumption of the load (3).

$$\begin{matrix}Math 2 & \\ C \leq 350 \times {10}^{- 6} \times \frac{P max}{{Vac}^{2}} & ( Expression 2 )\end{matrix}$$

Setting the capacitance of the capacitor (70) in this manner can reduce the fifth and seventh harmonics from the rectifier circuit (20).

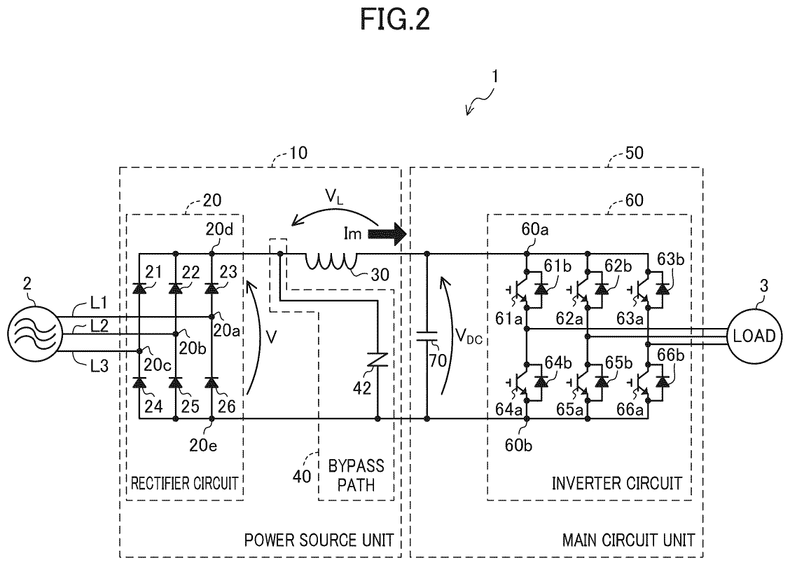

FIG. 2 shows a power converter (1) of a comparative example. In this comparative example, the bypass path (40) of the power converter (1) has no auxiliary winding (41). The other configuration of the comparative example is the same as, or similar to, that of the first embodiment.

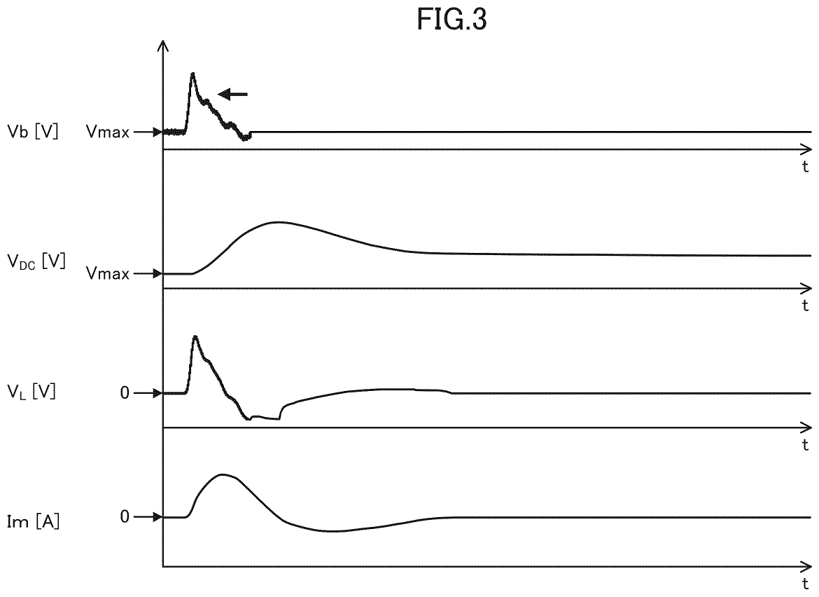

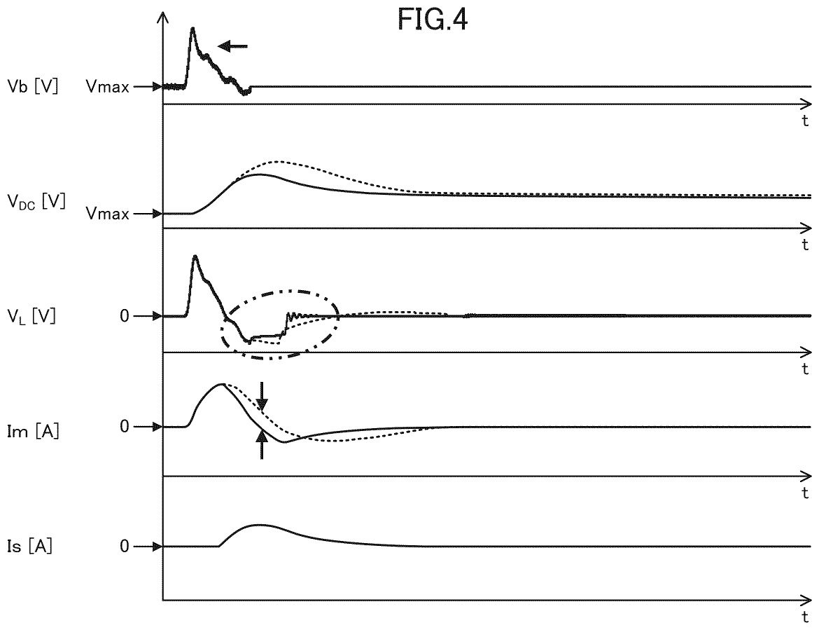

FIG. 3 shows the voltage Vb across the bypass path (40), the input voltage VDC of the main circuit unit (50), the voltage VL in the main winding (30), and the current Im in the main winding (30) measured in the comparative example in order from the top. FIG. 4 shows the voltage Vb across the bypass path (40), the input voltage VDC of the main circuit unit (50), the voltage VL in the main winding (30), the current Im in the main winding (30), and the current Is in the auxiliary winding (41) measured in the first embodiment in order from the top with solid lines. FIG. 4 also shows the voltage Vb across the bypass path (40), the input voltage VDC of the main circuit unit (50), the voltage VL in the main winding (30), and the current Im in the main winding (30) measured in the comparative example with broken lines. The voltages and currents shown in FIGS. 3 and 4 are those obtained when the switching of the switching elements (61a to 66a) of the inverter circuit (60) is stopped by the control of the control device (not shown). In FIGS. 3 and 4, Vmax represents a peak value of the power source voltage supplied by the power source (2) when no lightning surge occurs.

If the lightning surge occurs in the circuit of the first embodiment, the voltage Vb across the bypass path (40) increases as indicated by an arrow in FIG. 4. In response to the voltage increase, the current Im including the lightning surge current flows through the main winding (30), and electric charges gradually build up in the capacitor (70), increasing the input voltage VDC of the main circuit unit (50). The lightning surge current is a current superimposed on a current that flows at a voltage normally supplied from the power source (2). The lightning surge current flows when the voltage of the power source (2) increases in the event of the lightning surge. Further, part of the current including the lightning surge current superimposed on the current from the power source (2) flows as the current Is through the bypass path (40) including the auxiliary winding (41), reducing the current flowing from the power source (2) and the power source unit (10) to the main circuit unit (50). When the current Is flows through the bypass path (40), the auxiliary winding (41) changes the magnetic flux passing through the main winding (30) using the electrical energy sent to the bypass path (40), and generates a voltage in the main winding (30), that is, between the power source (2) and the main circuit unit (50), in a direction that keeps the current including the lightning surge current from flowing through the main circuit unit (50). This increases an equivalent impedance between the power source (2) and the main circuit unit (50). Thus, when the current Is flows through the bypass path (40) in the event of the lightning surge, the voltage VL in the main winding (30) is higher in the first embodiment than that in the comparative example as can be seen in the part enclosed by the two dot chain line in FIG. 4. As indicated by the arrow in FIG. 4, the current Im in the main winding (30) is smaller than that in the comparative example. As a result, the increase of the input voltage VDC of the main circuit unit (50) can be reduced as compared with the comparative example. Thus, the main circuit unit (50) is less susceptible to damage caused by the lightning surge than in the comparative example.

In the first embodiment, when the lightning surge current is superimposed on the current from the power source (2), the current flowing from the power source (2) to the main winding (30) and the capacitor (70) can be reduced as compared with the comparative example. Thus, the main winding (30) and the capacitor (70) can be reduced in size as compared with the comparative example.

In the first embodiment, the entry of the lightning surge current into the main circuit unit (50) can be blocked by using the electrical energy of the lightning surge current. Thus, the energy can be effectively used.

Further, the varistor (42) is provided in the bypass path (40) of the first embodiment, regulating the current flowing through the bypass path (40) when no lightning surge occurs. In the event of the lightning surge, the surge absorber (42) is short-circuited to allow the current to flow through the bypass path (40). Thus, there is no need to cause a computer to control whether or not to pass the current through the bypass path (40), and a delay time from the occurrence of the lightning surge to the flow of the current through the bypass path (40) can be shortened.

FIGS. 3 and 4 show the voltages and the currents while the switching of the switching elements (61a to 66a) is stopped. While the switching of the switching elements (61a to 66a) is stopped, the charges in the capacitor (70) do not flow to the load (3), increasing the input voltage VDC of the main circuit unit (50) more significantly. However, the current flowing from the power source (2) to the main winding (30) and the capacitor (70) in the event of the lightning surge can be effectively reduced also when the switching elements (61a to 66a) are caused to perform the switching operation to supply the current to the load (3).

### Variation of First Embodiment

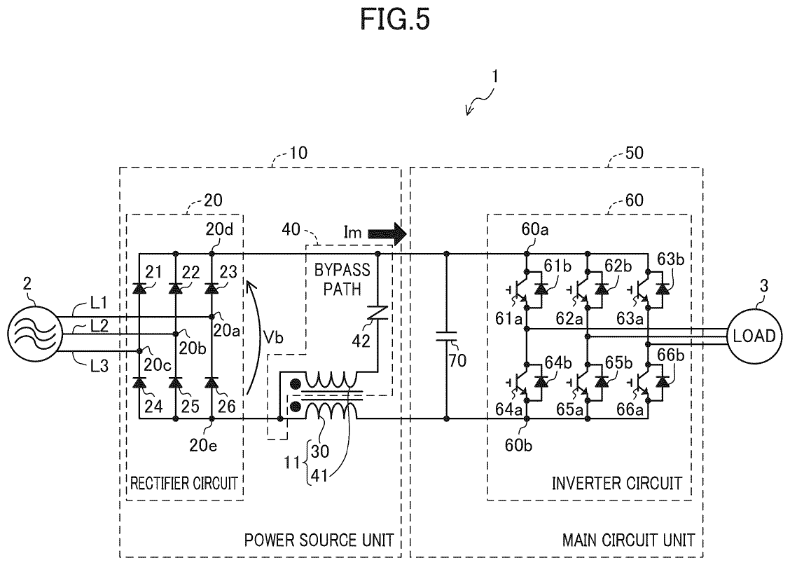

FIG. 5 shows a power converter (1) according to a variation of the first embodiment of the present disclosure. In this variation, one end of the main winding (30) is connected to the second output terminal (20e) of the rectifier circuit (20), and the other end of the main winding (30) is connected to the second input node (60b) of the inverter circuit (60). The first input node (60a) of the inverter circuit (60) is connected to the first output terminal (20d) of the rectifier circuit (20). The bypass path (40) is provided with an auxiliary winding (41) and a varistor (42) arranged in order from the second output terminal (20e).

This variation is configured in the same manner as the first embodiment except for these features. Thus, the same components will be indicated by the same reference characters and will not be described in detail.

### Second Embodiment

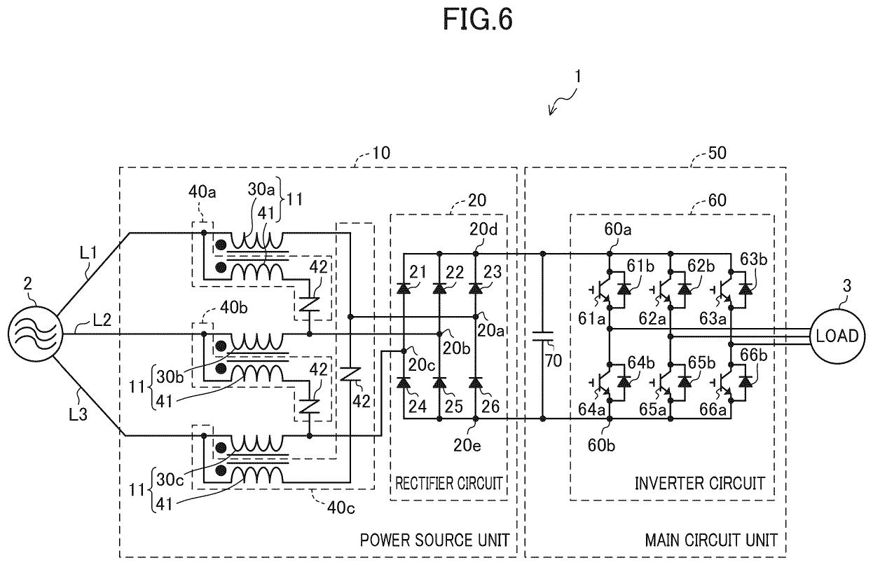

FIG. 6 shows a power converter (1) according to a second embodiment of the present disclosure. According to the second embodiment, first to third main windings (30a to 30c) and first to third bypass paths (40a to 40c) are provided between the power source (2) and the rectifier circuit (20).

Specifically, the first main winding (30a) is provided between the power source (2) and the first input terminal (20a) of the rectifier circuit (20), that is, on the first power line (L1).

The second main winding (30b) is provided between the power source (2) and the second input terminal (20b) of the rectifier circuit (20), that is, on the second power line (L2).

The third main winding (30c) is provided between the power source (2) and the third input terminal (20c) of the rectifier circuit (20), that is, on the third power line (L3). The bypass path (40) includes the first to third bypass paths (40a to 40c).

One end of the first bypass path (40a) is connected to the first power line (L1) at a position closer to the power source (2) than the first main winding (30a). The other end of the first bypass path (40a) is connected to the second power line (L2) at a position closer to the rectifier circuit (20) than the second main winding (30b). The auxiliary winding (41) and varistor (42) of the first bypass path (40a) are connected in order from the first power line (L1).

One end of the second bypass path (40b) is connected to the second power line (L2) at a position closer to the power source (2) than the second main winding (30b). The other end of the second bypass path (40b) is connected to the third power line (L3) at a position closer to the rectifier circuit (20) than the third main winding (30c). The auxiliary winding (41) and varistor (42) of the second bypass path (40b) are connected in order from the second power line (L2).

One end of the third bypass path (40c) is connected to the third power line (L3) at a position closer to the power source (2) than the third main winding (30c). The other end of the third bypass path (40c) is connected to the first power line (L1) at a position closer to the rectifier circuit (20) than the first main winding (30a). The auxiliary winding (41) and varistor (42) of the third bypass path (40c) are connected in order from the third power line (L3).

The second embodiment is configured in the same manner as the first embodiment except for these features. Thus, the same components will be indicated by the same reference characters and will not be described in detail.

### Third Embodiment

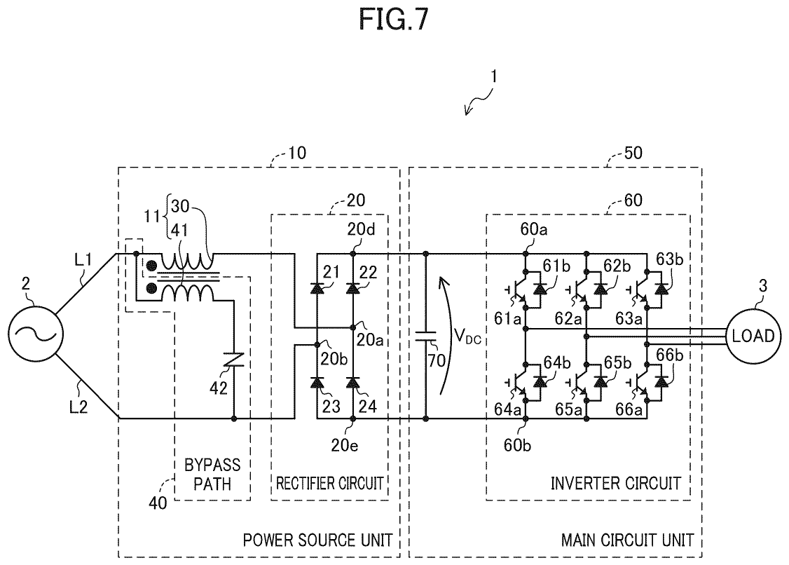

FIG. 7 shows a power converter (1) according to a third embodiment of the present disclosure. In the third embodiment, the power source (2) is a single-phase AC power source. Thus, the rectifier circuit (20) includes only the first and second input terminals (20a, 20b) as the input terminals connected to the first and second power lines (L1, L2). The rectifier circuit (20) has four diodes (21 to 24). The main winding (30) is provided between the power source (2) and the rectifier circuit (20). That is, the rectifier circuit (20) is connected to the power source (2) via the main winding (30).

Specifically, the main winding (30) is provided on the first power line (L1), that is, between the power source (2) and the first input terminal (20a) of the rectifier circuit (20).

One end of the bypass path (40) is connected to the first power line (L1) at a position closer to the power source (2) than the main winding (30). The other end of the bypass path (40) is connected to the second power line (L2). The auxiliary winding (41) and the varistor (42) are connected in order from the first power line (L1).

The capacitance of the capacitor (70) is set to allow the output voltage of the rectifier circuit (20) to pulsate with the maximum value twice or more the minimum value.

The third embodiment is configured in the same manner as the first embodiment except for these features. Thus, the same components will be indicated by the same reference characters and will not be described in detail.

### Variation of Third Embodiment

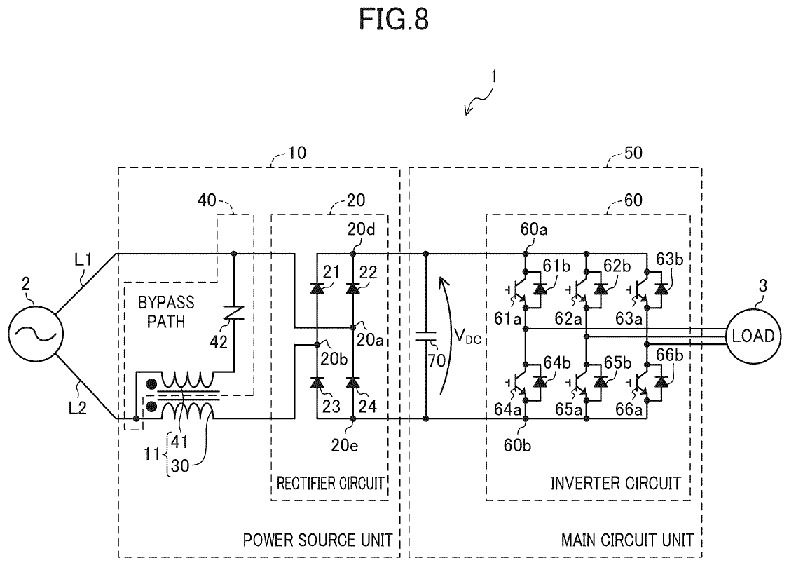

FIG. 8 shows a power converter (1) according to a variation of the third embodiment of the present disclosure. In this variation, the main winding (30) is provided on the second power line (L2), that is, between the power source (2) and the second input terminal (20b) of the rectifier circuit (20). One end of the bypass path (40) is connected to the second power line (L2) at a position closer to the power source (2) than the main winding (30). The other end of the bypass path (40) is connected to the first power line (L1). The auxiliary winding (41) and the varistor (42) are connected in order from the second power line (L2).

This variation is configured in the same manner as the third embodiment except for these features. Thus, the same components will be indicated by the same reference characters and will not be described in detail.

### FOURTH EMBODIMENT

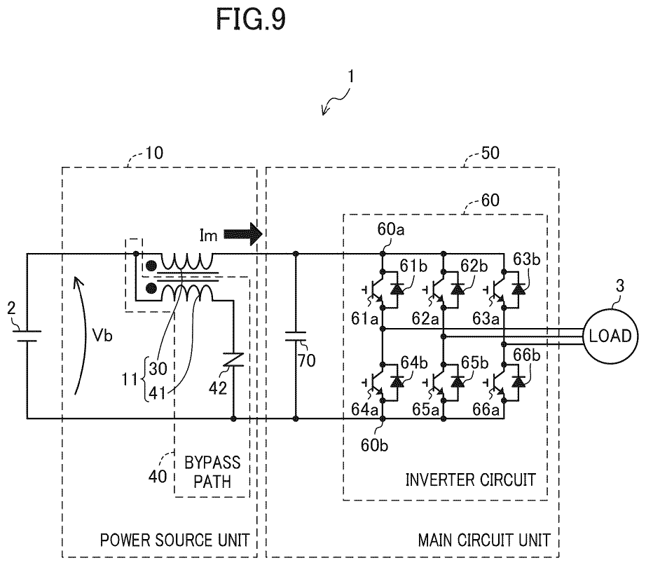

FIG. 9 shows a power converter (1) according to a fourth embodiment of the present disclosure. The power source (2) of the fourth embodiment is a DC power source. The power source unit (10) has no rectifier circuit (20).

The fourth embodiment is configured in the same manner as the first embodiment except for these features. Thus, the same components will be indicated by the same reference characters and will not be described in detail.

The first embodiment may be modified by using a single-phase AC power source as the power source (2) and replacing the rectifier circuit (20) with the rectifier circuit (20) of the third embodiment, i.e., the rectifier circuit (20) including the four diodes (21 to 24).

In the first to fourth embodiments and the variations of the first and third embodiments, the inverter circuit (60) may be replaced with a different power conversion circuit such as a DC-DC converter capable of performing power conversion such as boosting or stepping down a DC voltage by a switching operation. The power conversion circuit may constitute the main circuit unit (50).

In the first to fourth embodiments and the variations of the first and third embodiments, the main circuit unit (50) has the power conversion function by the inverter circuit (60), but the main circuit unit (50) may have no power conversion function.

In the first to fourth embodiments and the variations of the first and third embodiments, the diodes (21 to 26) may be replaced with IGBTs or power MOSFETs including wide bandgap semiconductors such as silicon carbide or gallium nitride in part or all of the rectifier circuit (20).

It will be understood that the embodiments and variations described above can be modified with various changes in form and details without departing from the spirit and scope of the claims. The above embodiments and variations may be appropriately combined or replaced as long as the functions of the target of the present disclosure are not impaired.

As can be seen in the foregoing, the present disclosure is useful as an electric circuit including a power source unit and a main circuit unit configured to receive electric power from a power source via the power source unit.

1. An electric circuit comprising:
a power source unit; and
a main circuit unit configured to receive electric power from a power source via the power source unit,
the power source unit including
a bypass path configured to allow part of a current including a lightning surge current superimposed on a current from the power source to flow, and
an impedance increasing circuit configured to increase an equivalent impedance between the power source and the main circuit unit based on the current flowing through the bypass path.

2. The electric circuit of claim 1, wherein
the impedance increasing circuit is configured to increase the impedance using electrical energy sent to the bypass path when part of the current including the lightning surge current flows through the bypass path.

3. The electric circuit of claim 1, wherein
the impedance increasing circuit is configured to generate a voltage between the power source and the main circuit unit in a direction that keeps the current including the lightning surge current from flowing through the main circuit unit based on the current flowing through the bypass path.

4. The electric circuit of claim 1, wherein
the impedance increasing circuit includes
a main winding provided on a path configured to supply the electric power from the power source to the main circuit unit, and
an auxiliary winding provided on the bypass path and magnetically coupled to the main winding, and
the impedance increasing circuit is configured to generate the voltage by changing a magnetic flux passing through the main winding by passing part of the current including the lightning surge current through the auxiliary winding.

5. The electric circuit of claim 4, wherein
the bypass path is provided with a surge absorber connected in series to the auxiliary winding.

6. The electric circuit of claim 4, wherein
the main winding and the auxiliary winding have polarities in a same direction.

7. The electric circuit of claim 1, wherein
the power source is an AC power source, and the power source unit includes a rectifier circuit configured to rectify an alternating current outputted from the power source, and
the main circuit unit includes
an inverter circuit configured to convert a direct current outputted from the rectifier circuit to an alternating current by a switching operation, and
a capacitor connected between input nodes of the inverter circuit and configured to allow an output voltage of the rectifier circuit to pulsate.

8. The electric circuit of claim 2, wherein
the impedance increasing circuit is configured to generate a voltage between the power source and the main circuit unit in a direction that keeps the current including the lightning surge current from flowing through the main circuit unit based on the current flowing through the bypass path.

9. The electric circuit of claim 2, wherein
the impedance increasing circuit includes
a main winding provided on a path configured to supply the electric power from the power source to the main circuit unit, and
an auxiliary winding provided on the bypass path and magnetically coupled to the main winding, and
the impedance increasing circuit is configured to generate the voltage by changing a magnetic flux passing through the main winding by passing part of the current including the lightning surge current through the auxiliary winding.

10. The electric circuit of claim 3, wherein
the impedance increasing circuit includes
a main winding provided on a path configured to supply the electric power from the power source to the main circuit unit, and
an auxiliary winding provided on the bypass path and magnetically coupled to the main winding, and
the impedance increasing circuit is configured to generate the voltage by changing a magnetic flux passing through the main winding by passing part of the current including the lightning surge current through the auxiliary winding.

11. The electric circuit of claim 5, wherein
the main winding and the auxiliary winding have polarities in a same direction.

12. The electric circuit of claim 2, wherein
the power source is an AC power source, and the power source unit includes a rectifier circuit configured to rectify an alternating current outputted from the power source, and
the main circuit unit includes
an inverter circuit configured to convert a direct current outputted from the rectifier circuit to an alternating current by a switching operation and
a capacitor connected between input nodes of the inverter circuit and configured to allow an output voltage of the rectifier circuit to pulsate.

13. The electric circuit of claim 3, wherein
the power source is an AC power source, and the power source unit includes a rectifier circuit configured to rectify an alternating current outputted from the power source, and
the main circuit unit includes
an inverter circuit configured to convert a direct current outputted from the rectifier circuit to an alternating current by a switching operation and
a capacitor connected between input nodes of the inverter circuit and configured to allow an output voltage of the rectifier circuit to pulsate.

14. The electric circuit of claim 4, wherein
the power source is an AC power source, and the power source unit includes a rectifier circuit configured to rectify an alternating current outputted from the power source, and
the main circuit unit includes
an inverter circuit configured to convert a direct current outputted from the rectifier circuit to an alternating current by a switching operation and
a capacitor connected between input nodes of the inverter circuit and configured to allow an output voltage of the rectifier circuit to pulsate.

15. The electric circuit of claim 5, wherein
the power source is an AC power source, and the power source unit includes a rectifier circuit configured to rectify an alternating current outputted from the power source, and
the main circuit unit includes
an inverter circuit configured to convert a direct current outputted from the rectifier circuit to an alternating current by a switching operation and
a capacitor connected between input nodes of the inverter circuit and configured to allow an output voltage of the rectifier circuit to pulsate.

16. The electric circuit of claim 6, wherein
the power source is an AC power source, and the power source unit includes a rectifier circuit configured to rectify an alternating current outputted from the power source, and
the main circuit unit includes
an inverter circuit configured to convert a direct current outputted from the rectifier circuit to an alternating current by a switching operation and
a capacitor connected between input nodes of the inverter circuit and configured to allow an output voltage of the rectifier circuit to pulsate.

17. The electric circuit of claim 8, wherein
the impedance increasing circuit includes
a main winding provided on a path configured to supply the electric power from the power source to the main circuit unit, and
an auxiliary winding provided on the bypass path and magnetically coupled to the main winding, and
the impedance increasing circuit is configured to generate the voltage by changing a magnetic flux passing through the main winding by passing part of the current including the lightning surge current through the auxiliary winding.

18. The electric circuit of claim 9, wherein
the bypass path is provided with a surge absorber connected in series to the auxiliary winding.

19. The electric circuit of claim 10, wherein
the bypass path is provided with a surge absorber connected in series to the auxiliary winding.

20. The electric circuit of claim 18, wherein
the main winding and the auxiliary winding have polarities in a same direction.
